(19) United States
(12) Patent Application Publication
(10) Pub. No.: US 2013/0021798 A1
(43) Pub. Date: Jan. 24, 2013

(54) LIGHT SHIELDING PLATE OF OUTDOOR LED LIGHTING DEVICE

(71) Applicants: CHUNG-JUNG CHEN, HSINCHU (TW); YU-SHENG CHEN, HSINCHU (TW); KUO-HUI CHANG, HSINCHU (TW)

(72) Inventors: CHUNG-JUNG CHEN, HSINCHU (TW); YU-SHENG CHEN, HSINCHU (TW); KUO-HUI CHANG, HSINCHU (TW)

(73) Assignee: EXCELLENCE OPTOELECTRONICS INC., HSINCHU (TW)

(21) Appl. No.: 13/188,624

(22) Filed: Jul. 22, 2011

(51) Int. Cl. F21V 5/00; F21S 4/00

(52) U.S. Cl. 362/244; 362/249.02

(57) ABSTRACT

A light shielding plate of an outdoor LED lighting device, comprising a main body disposed on a light exit plane of said outdoor LED lighting device. On a bottom surface of said main body is provided with at least a protrusion block, to reflect lights coming from LEDs or said LEDs plus a secondary lens set of said outdoor LED lighting device, in achieving light shielding effect. Moreover, on a reflection plane of said protrusion block is further provided with curved planes of various designs, to fully utilize the shielded light, so that lights are redistributed in areas of effective illumination, in further realizing power saving requirements.

### BACKGROUND OF THE INVENTION

1. Field of the Invention

The present invention relates to a light shielding plate, and in particular to a light shielding plate of an outdoor LED lighting device.

2. The Prior Arts

Nowadays, in order to provide sufficient illumination outdoors at night, lighting device is an important and indispensable tool, to protect the safety of people walking outdoors and car drivers. By way of examples, in order to protect the safety of pedestrians and car drivers at night, lighting devices are put on both sides of the roads in general, and that constitutes an essential part of Basic Public Utility. For this reason, light-emitting-diode (LED) has become a mainstay of lighting for now and future, since it can achieve both energy conservation and environment protection, due to its advantages of long service life, low power consumption, fast response speed, high efficiency, and energy conservation.

Refer to FIG. 1, for a schematic diagram of an ordinary LED street light. As shown in FIG. 1, a conventional LED street light 10 mainly comprises: a hood (or main body of LED street light) 12; and a substrate 14 installed on the hood 12, on the surface of the substrate 14 is provided with a plurality of LEDs or LEDs plus a secondary lens set 16. In providing illumination, lights supplied by LEDs or LEDs plus a secondary lens set 16 will emit out in all directions. In such a case, when this kind of LED lighting device is placed in residential area, it could lead to light trespass to the residents in this area, to become a problem or serious threat to the residents inside. Since the lights of LED street light getting into the room of the house could interfere with the normal routine of daily life, such as sleeping of the residents, or even seriously affect the generation of hormone in human body, hereby leading to the danger of incurring cancer. In order to solve the problem of light trespass for LED street lights, the present approach is to install a long and protruded light shielding cover 18 or a long light shielding plate on the hood (or main body of LED street light) 12, to block the light from getting into the room of the residence. However, for this approach of light shielding, not only its outer appearance seems rather odd, but it could also adversely affect the safety of the maintenance staff repairing or replacing the LED street lights. In addition, it could harm the birds flying around, also, the blocked light can not be used effectively, thus leading to waste of electricity.

Therefore, presently, the design and performance of light shielding plate for outdoor LED lighting device of the prior art is not quite satisfactory, and it has much room for improvement.

### SUMMARY OF THE INVENTION

In view of the problems and shortcomings of the prior art, the present invention provides a light shielding plate of outdoor LED lighting device, that can solve the problem of the prior art.

A major objective of the present invention is to provide a light shielding plate of outdoor LED lighting device. Wherein, at least a protrusion block is disposed on the main body, to reflect and redistribute lights emitted by LEDs or LEDs plus a secondary lens set, in realizing the effect of shielding lights.

Another objective of the present invention is to provide a light shielding plate of outdoor LED lighting device. Wherein, the reflecting surface of the protrusion block is provided with curved surfaces of various designs, to fully utilize the shielded light, so that lights can be re-distributed in the effective illumination areas, in achieving the purpose of power saving.

A yet another objective of the present invention is to provide a light shielding plate of outdoor LED lighting device. Wherein, its design is matched with that of the outdoor LED lighting device, so that its contour and color can fully match with and be incorporated into those of the outdoor LED lighting device, so its appearance will not seem to be odd.

A still another objective of the present invention is to provide a light shielding plate of outdoor LED lighting device. Wherein, it can be adapted to use in various outdoor LED lighting devices, in achieving light shielding in various directions and positions.

In order to achieve the above-mentioned objective, the present invention provides a light shielding plate disposed on an outdoor LED lighting device. The outdoor LED lighting device includes a hood (or main body of LED street light); and a substrate disposed on the hood (or main body of LED street light), and on the surface of the substrate is provided with a plurality of LEDs or LEDs plus a secondary lens set.

The light shielding plate includes a main body disposed on the light exit plane of the outdoor LED lighting device, the main body is provided with at least a protrusion block, to reflect the light emitted by LEDs or LEDs plus a secondary lens set.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTIONS OF THE DRAWINGS

The related drawings in connection with the detailed descriptions of the present invention to be made later are described briefly as follows, in which:

FIG. 1 is a schematic diagram of an ordinary LED street light according to the prior art;

FIG. 2 is a schematic diagram of light shielding plate of outdoor LED lighting device according to an embodiment of the present invention;

FIG. 2(a) is a partial enlargement view of a portion of FIG. 2 of an outdoor LED lighting device according to the present invention;

FIG. 3 is a side view of a portion of light shielding plate of outdoor LED lighting device of FIG. 2;

FIG. 4 is a schematic diagram of a side of the protrusion block having vertical plane shape according to the present invention;

FIG. 5 is a schematic diagram of a side of the protrusion block having slant plane shape according to the present invention;

FIG. 6 is a schematic diagram of a side of the protrusion block having curved plane shape according to the present invention; and

FIG. 7 is a schematic diagram of light shielding plate of outdoor LED lighting device according to another embodiment of the present invention.

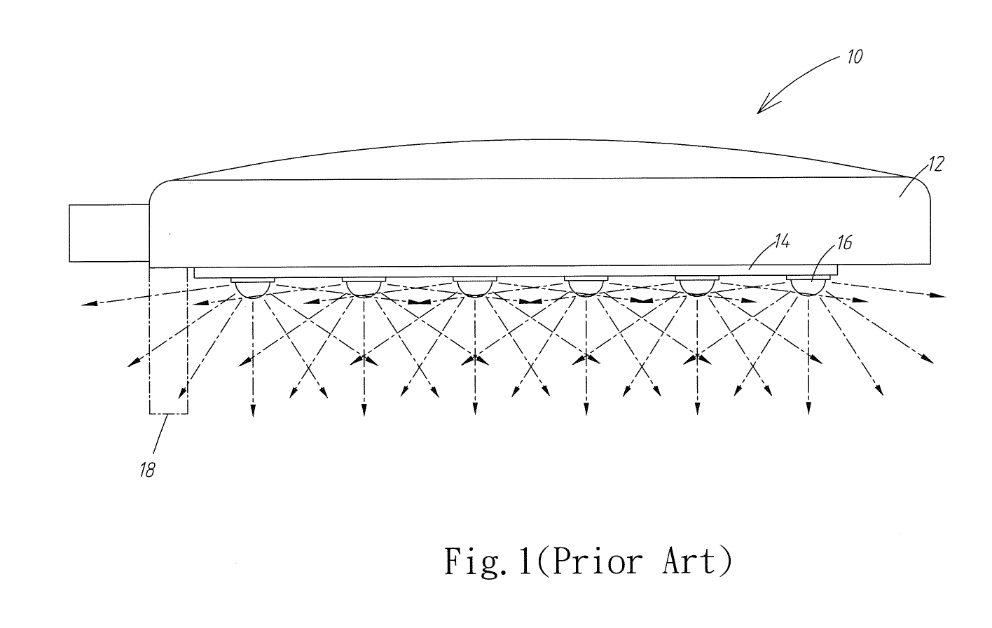

### DETAILED DESCRIPTIONS OF THE PREFERRED EMBODIMENT

The purposes, constructions, features, functions and advantages of the present invention can be appreciated and understood more thoroughly through the following detailed descriptions with reference to the attached drawings. And, in the following, various embodiments are described in explaining the technical characteristics of the present invention.

The present invention discloses a light shielding plate disposed on an outdoor LED lighting device, comprising: a main body, disposed on a light exit plane of an outdoor LED lighting device, and at least a protrusion block is provided on the main body, to shield, reflect, and distribute light emitted from LEDs or LEDs plus a secondary lens set of the outdoor LED lighting device, The outdoor LED lighting device referred to herein can be a street light, a park light, a landscape viewing light, or a wall washing light, etc.

The present invention makes use of the unique light emitting way and pointing characteristic of LEDs, and utilizes simple block structure and simplified installation method to adapt them to various outdoor LED lighting devices, in realizing light shielding of various directions and positions. In addition, the design of light shielding plate can match with that of outdoor LED lighting device, so its contour and color can be matched with and incorporated fully into the outdoor LED lighting device, such that its appearance can be pleasing and will not seem to be odd.

In the following, a few embodiments are described and explained, however, the present invention is not limited to these embodiments.

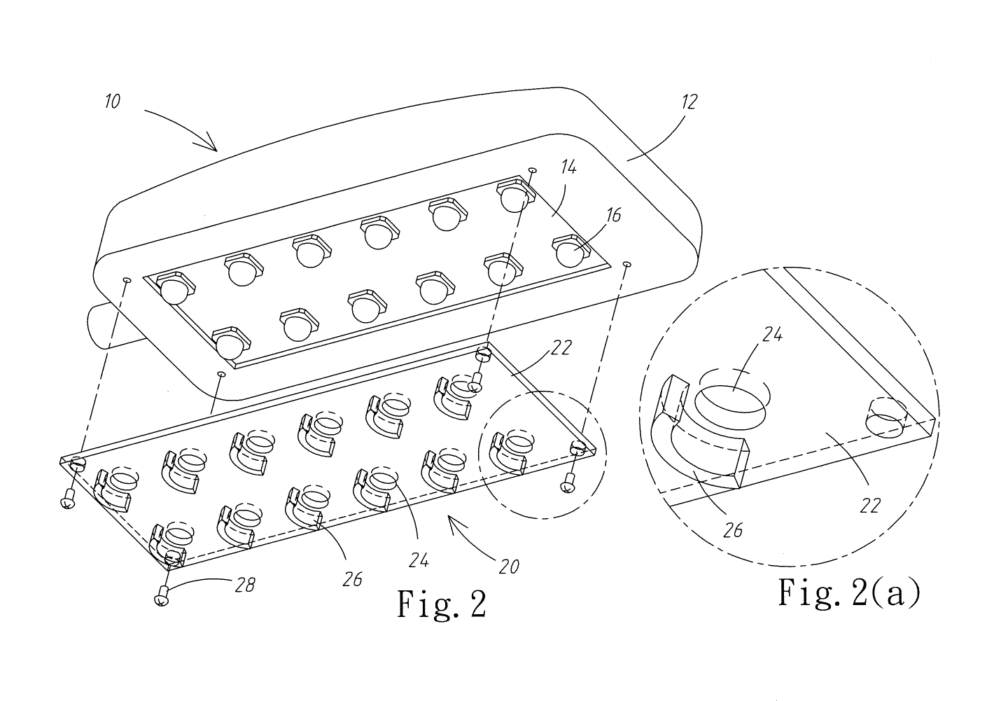

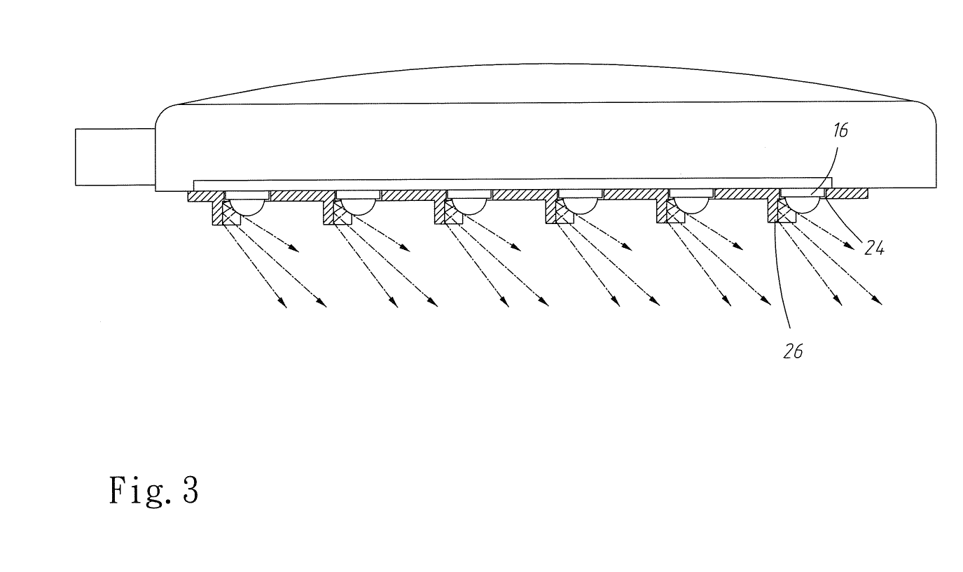

Refer to FIG. 2, FIG. 2(a), FIG. 3 for a schematic diagram of light shielding plate of outdoor LED lighting device according to an embodiment of the present invention; a partial enlargement view of a portion of FIG. 2; and a side view of FIG. 2 respectively.

As shown in the figures mentioned above, the outdoor LED lighting device 10 includes a hood (or main body of LED street light) 12; and a substrate 14 disposed on the hood (or main body of LED street light) 12, and a plurality of LEDs or LEDs plus a secondary lens set 16 are provided on the surface of the substrate 14. The light shielding plate 20 of the present invention includes a main body 22, and at least a hole slot 24 and at least a protrusion block 26 are provided on the main body 22. The hole slot 24 is used to expose LEDs or LEDs plus a secondary lens set 16, and the protrusion block 26 is placed around the perimeter of the hole slot 24 at the bottom surface of the main body 22, and the main body 22 can be made of metal, plastic, or glass.

When several protrusion blocks 26 are provided on the main body 22, the arrangement of protrusion blocks 26 is matched with that of the LEDs or LEDs plus a secondary lens set 16 on the substrate 14. When a plurality of protrusion blocks 26 are arranged around a single hole slot 24, these protrusion blocks 26 can be arranged into left-right symmetric, front-rear symmetric, or axial symmetric, in achieving shielding lights coming from various directions.

The present invention utilizes protrusion blocks 26 on the main body 22 to achieve light shielding effect. Compared with the light shielding hood or light shielding plate of the prior art, the size of the present invention is rather small and compact, thus it would not adversely affect the outer appearance of the outdoor LED lighting device, and it would not cause harm to the birds flying around either.

Furthermore, as shown in FIG. 2, the main body 22 can be locked and fixed onto the hood (or LED road light main body) 12 by using screws 28, but other ways can also be adopted, by way of example, sticking by means of glue, or clamping by means of spring plate.

In addition, curved surfaces of various designs can be formed on the reflection plane of the protrusion block 26, to fully utilize the shielded light, so that lights can be redistributed in areas of effective illumination, in achieving power saving. Moreover, the reflection plane of each protrusion block 26 on a single main body can be designed into various shapes, to fulfill the light shielding requirements needed for various road conditions and placement directions of the outdoor LED lighting device.

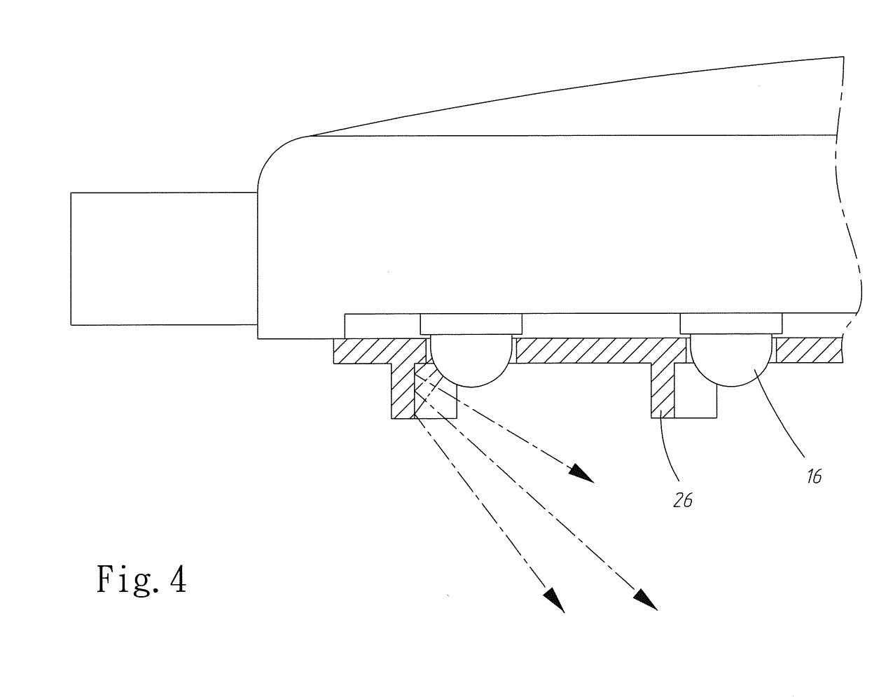

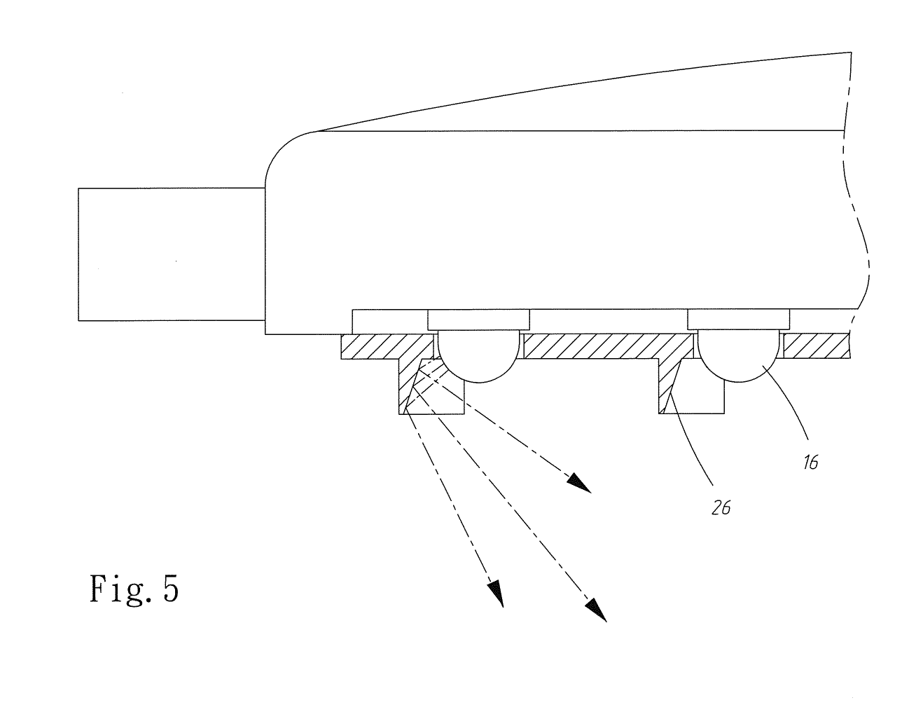

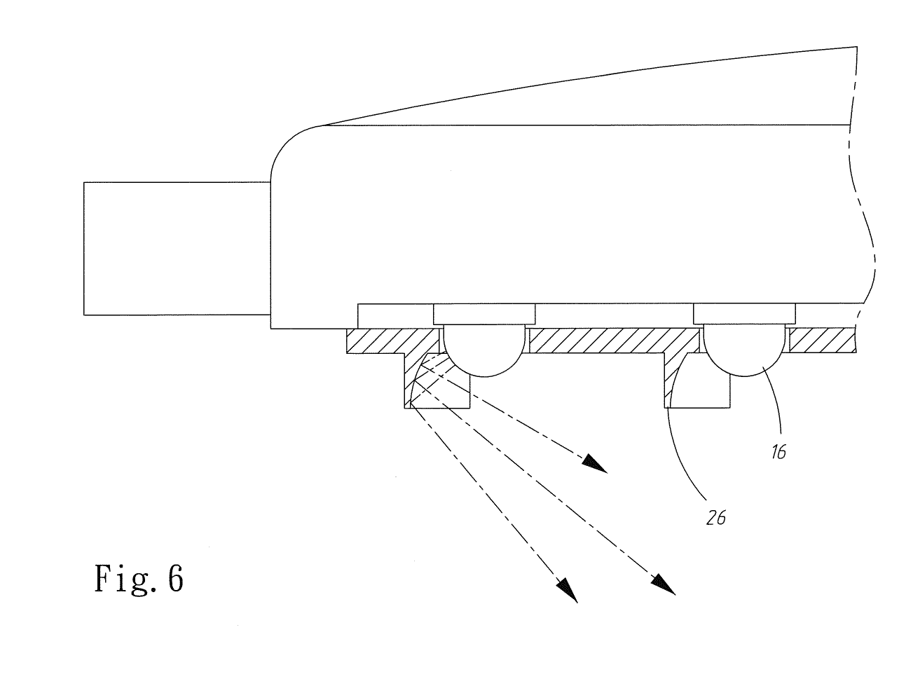

By way of example, in FIG. 4, the reflection plane of the protrusion block 26 facing LEDs or LEDs plus a secondary lens set 16 is of a vertical plane shape; in FIG. 5, the reflection plane of the protrusion block 26 facing LEDs or LEDs plus a secondary lens set 16 is of a slant plane shape; and in FIG. 6, the reflection plane of the protrusion block 26 facing LEDs or LEDs plus a secondary lens set 16 is of a curved plane shape.

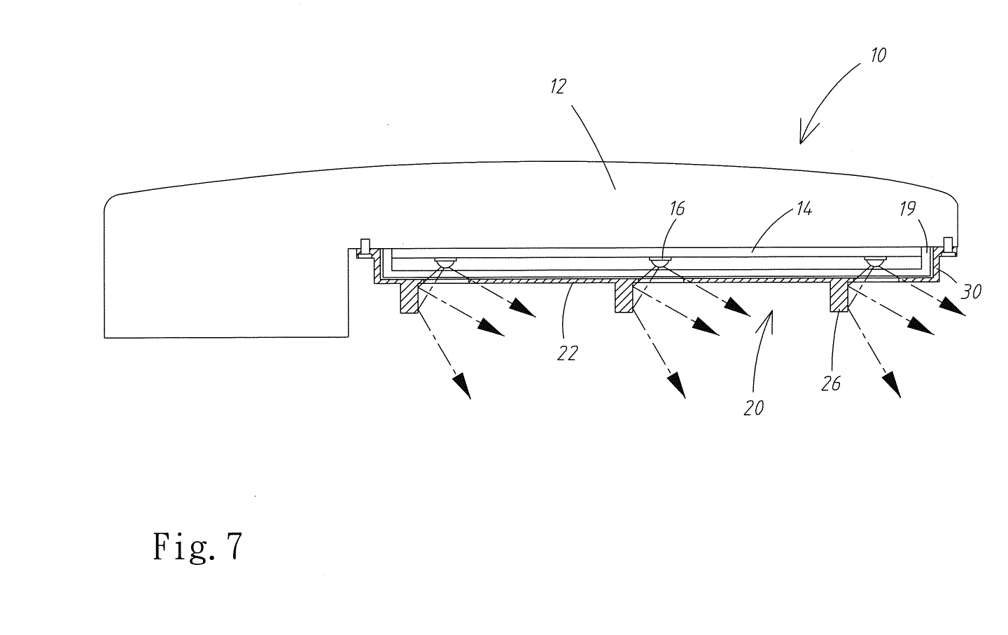

Finally, refer to FIG. 7 for a schematic diagram of light shielding plate of outdoor LED lighting device according to another embodiment of the present invention. The differences between the present embodiment and that of FIG. 2 are that, a transparent upper cover 19 is placed on the substrate 14 of outdoor LED lighting device 10. In addition, the transparent upper cover 19 can be of a flat plane structure, a curved plane structure, or a plurality of lenses can be disposed thereon.

Moreover, as shown in FIG. 7, in order to lock and fix the main body 22 onto the hood (or main body of LED street light) 12, and to match with the height of the transparent upper cover 19, side edge of the main body 22 can be extended upward to form an extended lock and fix portion 30.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A light shielding plate of an outdoor LED lighting device, disposed on said outdoor LED lighting device, which comprises a hood or main body of LED street light, and a substrate provided on said hood or said main body of LED street light, on surface of said substrate is provided with a plurality of LEDs or LEDs plus secondary lens set, said light shielding plate comprising:
a main body, disposed on a light exit plane of said outdoor LED lighting device, said main body is provided with at least a protrusion block, to reflect light coming from said LEDs or said LEDs plus said secondary lens set.

2. The light shielding plate of an outdoor LED lighting device as claimed in claim 1, wherein said main body is further provided with at least a hole slot, to expose said LEDs or said LEDs plus said secondary lens set, said protrusion block is located around perimeter of said hole slot.

3. The light shielding plate of an outdoor LED lighting device as claimed in claim 1, wherein a reflection plane of said protrusion block facing said LEDs or said LEDs plus said secondary lens set is a vertical plane, a slant plane, or a curved plane.

4. The light shielding plate of an outdoor LED lighting device as claimed in claim 2, wherein when a plurality of protrusion blocks are provided, said protrusion blocks are arranged into left-right symmetric, front-rear symmetric, or axial symmetric configuration.

5. The light shielding plate of an outdoor LED lighting device as claimed in claim 1, wherein said main body is made of metal, plastic, or glass.

6. The light shielding plate of an outdoor LED lighting device as claimed in claim 1, wherein said main body is fixed onto said outdoor LED lighting device through locking and fixing by means of screws, sticking by means of glue, or clamping by means of spring plates.

7. The light shielding plate of an outdoor LED lighting device as claimed in claim 1, wherein said outdoor LED lighting device further includes a transparent upper cover placed on said substrate, and said transparent upper cover is of a flat plane structure, a curved plane structure, or a plurality of lenses disposed thereon.

8. The light shielding plate of an outdoor LED lighting device as claimed in claim 1, wherein said outdoor LED lighting device is a street light, a park light, a landscape viewing light, or a wall washing light.
